(19) United States
(12) Patent Application Publication
(10) Pub. No.: US 2006/0280913 A1
(43) Pub. Date: Dec. 14, 2006

(54) Packing material and method for packing an object using the packing material

(76) Inventor: Taeko Yoshida, Ayase-shi (JP)

Correspondence Address: MURAMATSU & ASSOCIATES, Suite 310, 114 Pacifica, Irvine, CA, 92618, US

(21) Appl. No.: 11/370,729

(22) Filed: Mar. 8, 2006

(30) Foreign Application Priority Data
Mar. 8, 2005 (JP) 2005-64073

(51) Int. Cl. B32B 37/00; B32B 3/12

(52) U.S. Cl. 428/178; 53/456; 156/308.4

(57) ABSTRACT

A packing method for an object to be packaged is capable of packing the object therein in a stable manner by using a packing material obtained by a simple manufacturing method. The packing material is formed with two thermoplastic films overlapped with one another and heat-sealed at predetermined locations. Folds are created on the thermoplastic films by a heat-sealing process so that a base of the packing material is folded along the folds. The packing material having the product to be protected in a space created by folding thereof is placed in a container box and is inflated by gas or liquid.

### FIELD OF THE INVENTION

The present invention relates to a packing material and a packing method using the packing material for stabilizing an object to be packaged with packing material that uses gas or liquid as a buffer, thereby protecting the object from impact such as shocks and vibrations.

### BACKGROUND OF THE INVENTION

In general, various industrial products such as daily necessaries and home electrical appliances are packaged in box-like materials such as cardboard boxes, whereby they are shipped and stored. In order to fill in the space between the product (object) inside the container box and the inner walls of the container box, foam polystyrene packaging, for example, has been traditionally placed between the object and the inner side of the box as a buffer so that the object will be stabilized and protected.

However, such foam polystyrene packaging are usually discarded after one time use, and thus, it is not preferable from an ecological point of view related to waste management problems. In particular, the material in the foam polystyrene uses oil resource as raw material, thus the ongoing consumption in large amounts thereof should be reconsidered from the perspective of energy concerns.

Therefore, in Japanese Patent Laid-open Publication Nos. 5-051068 and 5-051067, for example, a collapsible buffering material for packing made of cardboard is proposed, where it is constructed by a main part and an auxiliary part formed with a rectangular box established with creases and slits in several places thereon. The collapsible buffering material can stabilize an object placed inside a cardboard box by folding up the cardboard material. The collapsible buffering material can be manufactured efficiently and inexpensively with a high buffering effect as well as collapse into a smaller size during storage and shipping.

However, in the technologies introduced by the Japanese Patent Publications noted above, the shape of the object is limited to be packed with high stability. Further, since the shape of the buffer material for protecting the object must vary depending on the shape of the object to be protected, the method for producing the buffering material becomes complicated and costly.

### SUMMARY OF THE INVENTION

Therefore, in view of the above situation, it is an object of the present invention to provide packing material for packing a product therein and a packing method using the packing material where the product is packed in a stable manner inside a container box, and the packaging material can be produced through a simple manufacturing process.

In the first aspect of the present invention, a packing material is comprised of plastic films overlapped with one another where the edges of the plastic films are heat-sealed and gas or liquid is injected in the plastic films. The plastic films are further formed with folds by heat-sealing for folding the packing material to store the product to be packaged in a space inside the plastic films created by folding the packing material along the folds.

In another aspect of the present invention, the packing material is established with partitions which are created by a heat sealing process or a film sheet and has at least one opening for injecting the gas or liquid.

In a further aspect of the present invention, the opening for injecting the gas or liquid into the packing material prevents the reverse flow of the gas or liquid by a labyrinth structure formed in a check valve.

In a further aspect of the present invention, the packaging material is provided with a check valve that prevents the reverse flow of the gas or liquid.

In a further aspect of the present invention, the check valve formed in the packing material is provided at the opening for injecting the gas or liquid.

In a further aspect of the present invention, the opening for injecting the gas or liquid in the packing material is provided through the plastic films.

In a further aspect of the present invention, the opening for injecting the gas or liquid in the packing material is provided for each of the partitions.

In a further aspect of the present invention, the packing material is injected with the gas or liquid after the product to be packaged is stored in the space created by the folds.

In a further aspect of the present invention, the packing material having the product to be protected therein is stored inside a container box.

In a further aspect of the present invention, the packing material is injected with the gas or liquid after the container box is closed.

In the second aspect of the present invention is a packing method using a packing material in which the packaging material is comprised of plastic films overlapped with one another where the edges of the plastic films are heat-sealed and gas or liquid is injected in the plastic films. The plastic films are further formed with folds by heat-sealing to store the product to be packaged in a space inside the plastic films created by the folds.

In another aspect of the packing method of the present invention, the packaging material is established with partitions which are created by a heat sealing process or a film sheet and has at least one opening for injecting the gas or liquid.

In a further aspect of the packing method of the present invention, the opening for injecting the gas or liquid into the packing material prevents the reverse flow of the gas or liquid by a labyrinth structure formed in a check valve.

In a further aspect of the packing method of the present invention, the packaging material is provided with a check valve that prevents the reverse flow of the gas or liquid.

In a further aspect of the packing method of the present invention, the check valve formed in the packing material is provided at the opening for injecting the gas or liquid.

In a further aspect of the packing method of the present invention, the opening for injecting the gas or liquid in the packing material is provided through the plastic films.

In a further aspect of the packing method of the present invention, the opening for injecting the gas or liquid in said packing material is provided for each of the partitions.

In a further aspect of the packing method of the present invention, the packing material is injected with the gas or liquid after the product to be packaged is stored in the space created by the folds.

In a further aspect of the packing method of the present invention, the packing material is stored inside a container box.

In a further aspect of the packing method of the present invention, the packing material is injected with the gas or liquid after the container box is closed.

By the above noted means to solve the above-identified problems, the packing method of the present invention can pack the objects of various shapes by a simple method where the object in the space of the packing material is packed in a stable and secure manner.

Further, the packaging material of the present invention can be easily manufactured, and since the gas or liquid is injected after an object is placed, objects of various shapes can be packed, and moreover, the packaging material itself can be easily stored and transported.

### BRIEF DESCRIPTION OF THE DRAWINGS

FIG. 1 is a plan view showing a base of the packing material incorporated in the first embodiment of the present invention.

FIG. 2 is an enlarged view showing the structure of packing material in the proximity of the sheet material X in accordance with the present invention.

FIG. 3 is a perspective view showing the packing material of the present invention when the packing material is folded up to form a rectangular structure.

FIG. 4 is a partially cut-out perspective view showing the packing material and container box of the present invention where the packing material is placed inside of the container box while having the object to be protected in the inner space of the packing material.

FIG. 5 is a perspective view showing an outer appearance of the container box in which a top cover thereof is closed after the object to be protected and the packing material are stored inside.

FIG. 6 is a schematic diagram showing an example of structure of the check valve incorporated in accordance with another embodiment of the present invention.

FIG. 7 is a schematic diagram showing an example of structure of the check valve Y incorporated in a further embodiment of the present invention.

FIG. 8 is a plan view showing a base of the packing material incorporated in the second embodiment of the present invention.

### DESCRIPTION OF THE PREFERRED EMBODIMENTS

The embodiments of the packing material and the packaging method for protecting an object in the present invention will be explained below with reference to the accompanying drawings.

### First Embodiment

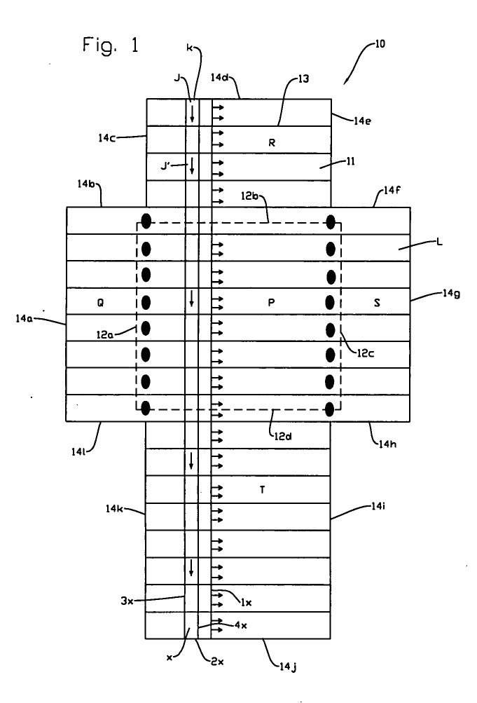

FIG. 1 is a plan view showing an example of structure of a base 11 of the packing material incorporated in the packing method of the first embodiment of the present invention for packing a product therein. The packing material 10 is comprised of a base 11 where two thermoplastic films (sheets) of the same shape and size are overlapped with one another to form a bottom P, sides Q, R, S, and a side and a top T, and a sheet material X that forms a check valve is provided between the two thermoplastic films that form the base 11. The sheet material X is provided between the two thermoplastic sheets as noted above so that it goes through the center of the base 11. The sheet material X also functions as an opening for injecting the gas or liquid into the packing material.

(Folds and Partitions)

The packing material 10 of the present invention is used when it is entirely inflated with the gas, typically air, which is supplied between the two thermoplastic films that form the base 11. It should be noted that, in the present embodiment, gas such as air is used to inflate the entire packing material 10, however, liquid can also be used as well to inflate the packing material 10.

Further, in the base 11 of the packing material 10, folds 12a-12d are provided which a series of small heat-sealed points for folding the base 11. Thus, when the gas is supplied to inflate the packing material 10, the folds 12a-12d promote to form a box-like shape of the packaging material 10. Further, in the base 11 of the packing material 10, partitions 13 are provided for dividing the packing material 10 into a plurality of chambers. The partitions 13 are formed on thermoplastic films of the packing material 10 in a manner that they are perpendicular to the direction of the sheet material X.

The partitions 13 are established in such a way that each of the plurality of chambers are parallel to the edge 14d (14j) of the packing material 10, and a distance L between the two partitions 13 is equal to one another. Further, a distance between the folds 12a and 12c and a distance between the folds 12b and 12d are properly established so that the folds 12a-12d can fit into the bottom of the container box 1 which will store the entire packing material 10.

When the gas or liquid is injected into the packing material 10, the distance (length) between the folds noted above may be shortened due to the inflation of the tube-like shape of the chambers resulting from the injection. Hence, it is preferable that the distances between the folds 12a-12d at the bottom P should be set so that the bottom P of the packing material 10 will fit with the bottom of the container box 1 after the gas is injected.

(Check Valve X)

The sheet material X achieves the effect of a check valve, and is formed by overlapping two rectangular thermoplastic films each being a thin, flexible film made of, for example, polyethylene. It is also possible to use only one sheet of film for the sheet material X that is used as a check valve.

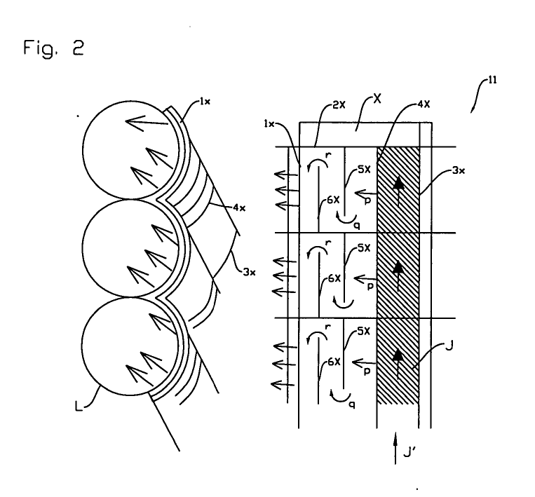

FIG. 2 shows an enlarged view of the structure of an area that surrounds the sheet material X. The structure includes heat-sealed portions 2x-4x for bonding the sheet material X to the two thermoplastic films forming the base 11 of the packing material 10, and partial heat-sealed portions 5x-6x for partially boding the sheet material X to the two thermoplastic films to create a flow maze (labyrinth). Further, an area for a flow path J indicated by diagonal lines is provided with a separation (peeling) agent so that this area will not be heat-sealed even when the heat-sealing process is applied thereto.

(Heat-Seal Portions)

As noted above, the packaging material 10 is formed by overlapping the two thermoplastic films of the same shape and size. The edges 14a-14l, the folds 12a-12d, and partitions 13 are heat-sealed so that the two thermoplastic films are bonded to one another.

When applying the heat-sealing process, by placing the above mentioned sheet material X between the two thermoplastic films and applying the heat to the heat-sealing portions 2x-4x and the partial heat-sealed portions 5x-6x along with the rest of the heat-seal portions (edges 14a-14l, the folds 12a-12d, and partitions 13), the packing material 10 provided with the sheet material X can be efficiently formed through one heat-sealing process. As noted above, the partial heat-sealed portions 5x and 6x form the labyrinth structure with narrow gas flow paths q and r so that the sheet material X can function as a check valve.

(Partial Heat-Seal)

Further, the folds 12a-12d are heat-sealed in such a way that they are alternately established with a small heat-sealed area and a non-heat-sealed area. Thus, the gas (liquid) can flow through the non-heat-sealed area created between the heat-sealed areas. In the same manner, even on the heat-sealed portions 4x of the sheet material X, a non-heat-sealed area p must be established so that the gas or liquid can flow through each row (chamber) L of the packing material 10.

In the present embodiment, at the partitions 13, the two thermoplastic films are entirely bonded by the heat so that each chamber (row L) is independent from one another, thus unaffected by other chamber.

(Material Constituting Packing Material)

In this present embodiment, the thermoplastic films forming the packing material are made of a type of film (heat-seal type film) that is welded by the heat such as polyethylene or polypropylene that is laminated with a nylon, fluorocarbon resin, or silicon film. The heat-seal type film should be an outer surface of the packing material because the outer surface of the thermoplastic film must adhere to another thermoplastic film by the heat in order to construct the packing material of the present invention.

Further, the thermoplastic films for forming the packing material of the present invention can also be made of two heat-seal type films such as polyethylene or polypropylene which sandwich the nylon, fluorocarbon resin, or silicon film therebetween. By doing so, the outer surface of each of the thermoplastic films can be adhered to another thermoplastic film by the heat, thereby making the packing material.

In the manufacturing process of the packing material 10 of the present invention, the packing material 10 provided with the non-heat-sealed points noted above can be manufactured when the sheet material X is placed between the two thermoplastic films that form the base 11. This is done by providing an adhesion inhibitor (peeling agent) such as heat resistant ink or photogravure in advance to locations correspond to the non-heat-sealed points on opposite surfaces of the two thermoplastic films of the packing material 10. Thus, when creating the heat-sealed portions such as edges 14a-14l, folds 12a-12d, partitions 13, heat-sealed portions 2x-4x, and partially heat-sealed portions 5x-6x by bonding the two thermoplastic films, the non-heat-sealed portions are also created through the heat-sealing process at the same time, thereby simplifying the manufacturing process.

As for the adhesion inhibitor, instead of applying the heat resistant ink, a material that will not produce any heat adhesion such as cellophane can be inserted between the thermoplastic films at the location where the heat-sealing should be avoided.

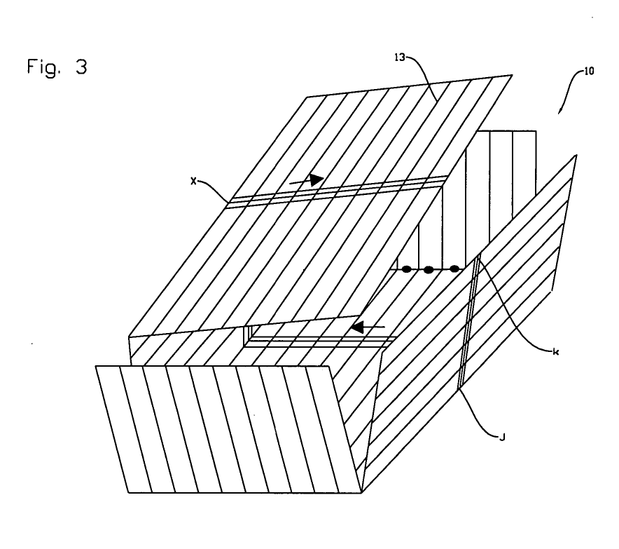

The packing material 10 of the present invention forms a rectangular parallelepiped structure shown in FIG. 3 by folding the thermoplastic film at the folds 12a-12d until the edge 14b contacts with the edge 14c, the edge 14e contacts with the edge 14f, the edge 14h contacts with the edge 14i, and the edge 14k contacts with the edge 14l, thereby forming a box like shape.

(Application)

Next, the application of the packing material 10 of the present invention structured as mentioned above will be explained. In the present invention, the packing material 10 is stored in an container box 1.

Furthermore, in the present invention, after forming the packing material 10 in a generally rectangular parallelepiped shape as shown in FIG. 3, the packing material 10 is placed inside the container box 1. After placing the product (object) 3 to be protected in an inner space of the packing material 10, a top cover of the container box 1 will be closed and the gas such as air will be injected through an opening G established on the top of the container box 1.

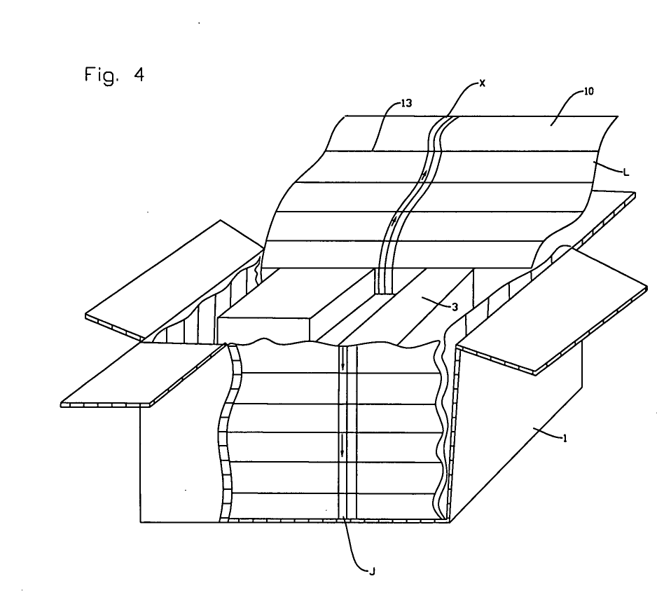

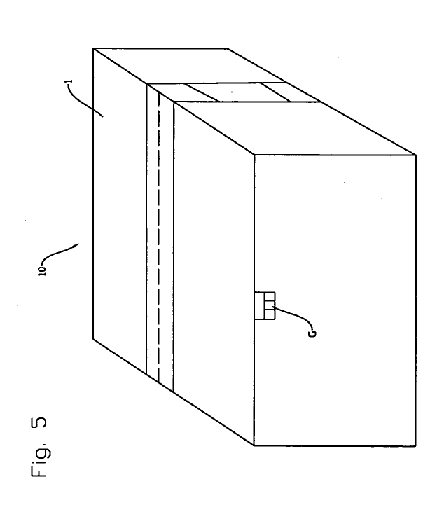

FIG. 4 shows the packing material 10 of the present invention which is placed inside of the container box 1 where the product 3 to be packed is stored therein, and FIG. 5 is a perspective view showing an example of outer appearance of the container box 1 where the top cover is closed after storing the product 3 and packing material 10 therein.

As shown in FIG. 5, in the present embodiment, the gas is injected into the packing material 10 through the opening G established on the top of the container box 1 after closing the top cover of the container box 1. Thus, the opening G must be connected to an opening k on the packing material 10 when the packing material 10 is placed inside the container box 1.

(Operation, Effect)

The sheet material X functions as a check valve provided with an opening for gas injection, where a gas tube is inserted in the direction of J′ as shown in the drawing through an opening k of the gas flow path J that has been painted entirely with peeling agents so that it will not be heat-sealed. When the gas is injected inside the tube, the gas passes through each row of the partially accessible (non-heat-sealed) points p as well as through each row of the narrow gas flow paths q and r which form the labyrinth structure, and finally through the end of the sheet material 1x and into each chamber of the packing material 10.

In other words, the gas supplied from the end 1x of the sheet material X inflates the entire packing material 10, where the gas flow paths on the sheet material X closes the gas flow paths and prevents the reverse flow of the gas due to the internal pressure.

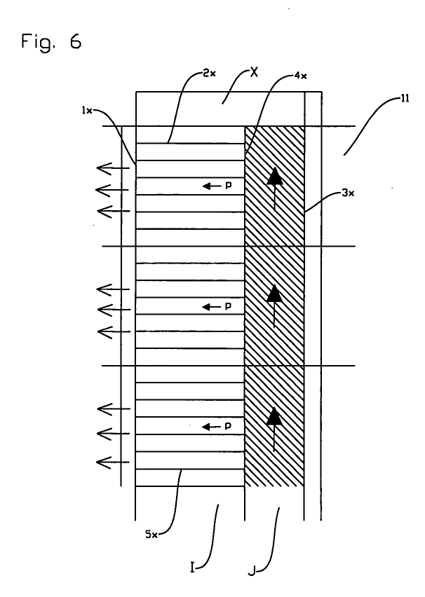

In FIG. 2, the sheet material X is structured so that the injected gas will not backwardly flow by the labyrinth structure formed by the partially heat-sealed portions 5x and 6x which are established in parallel to the gas flow direction J′ to form the narrow gas flow paths q and r. However, this structure for preventing the reverse flow of the gas is not limited to that shown in FIG. 2, and as shown in FIG. 6, narrow dividers 5x can be individually established for every narrow space in the entire gas flow path portion I so that the narrow dividers 5 prevent the reverse gas flow after the gas is introduced from the gas flow path J.

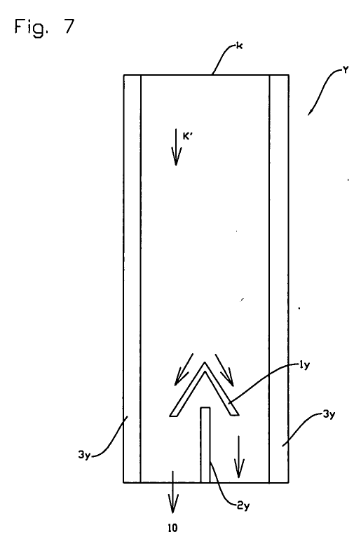

Further, instead of the sheet material X, a check valve Y provided with an opening for gas injection can be established to prevent the reverse flow of the gas that has been injected to the inside. FIG. 7 is a schematic diagram showing such an example of the check valve Y in another embodiment of the present invention. This check valve Y is formed with two rectangular thermoplastic films such as polyethylene overlapped with one another. The thermoplastic films are heat-sealed at predetermined portions 1y, 2y and 3y while other portions are not heat-sealed by applying the peeling agents between the films. As a result, the check valve Y is comprised of a structure that prevents the reverse flow of the gas when the gas is injected through the opening K provided on the check valve Y in the direction K′ of the packing material 10.

Since the heat-seal is established over all of the partitions 13 of the base 11 of the packing material 10 shown in FIG. 1, the check valve Y in this case must be provided on each and every row (chamber) L formed by the partitions 13 and the edges 14a, 14c, 14k or edges 14e, 14g, 14i by inserting the check valve Y between the two thermoplastic films forming the base 11 of the packing material 10.

This type of plastic check valve is publicly known, for example, from Japanese Patent Laid-open Publication No. 7-10159, thus no further details will be described here.

In the present embodiment, since the heat-seal is established for all of the partitions 13, when using the check valve Y provided with an opening K such as the one mentioned above as one unit, it must be provided on each and every row L formed by the partitions 13.

Further, in the present embodiment described in the foregoing, the heat-seal is established on all of the partitions 13, however the partitions can be established by a series of partially heat-sealed points as well. When the packing material 10 established with partially heat-sealed points on the partitions 13 is provided with the above mentioned check valve Y, the entire packing material 10 can be inflated by using only check valve Y.

Moreover, in the present embodiment, the heat-seal is established at the partitions, however such a partition can also be established by inserting a plastic film of short width between the two thermoplastic films forming the base where the plastic film are heat-sealed to the two thermoplastic films.

Further, the partially heat-sealed points and the partially non-heat-sealed points are created alternately on the folds 12a-12d, thus the gas supplied inside the packing material 10 as explained above passes through the partially non-heat-sealed points on the folds 12a-12d to securely inflate the entire packing material 10.

Further, by establishing the partially non-heat-sealed points on the folds 12a-12d, a freedom of folding. the packing material is created around the folds rather than the situation where the heat-seal is uniformly established along the entire folds.

In the present invention, the heat-seal is uniformly established on the partitions 13 so that the gas will not pass between the adjacent rows (chambers). Therefore, even if one of the rows (chambers) is broken by an impact, etc., the packing material 10 as a whole will not be affected and can be continuously used since the rows (chambers) are independent from one another.

As shown in FIG. 4, the present invention is directed to the packing material 10 having a generally flat sheet like shape made of two thermoplastic films and check valves. The packing material 10 covers all six inner walls of the container box 1, where the force of impact received from outside of the container box 1 is absorbed by a cushion effect of the packing material 10. As a result, the object 3 to be protected inside the container box 1 can maintain a safe packing condition without receiving any significant impact by using the simple and inexpensive packing method of the present invention.

Moreover, after placing the object 3 to be protected in such a manner that there are some remaining spaces in the space formed by the packing material 10, the gas is supplied to the inside of the packing material 10. Thus, the object 3 and the packing material 10 becomes closely contact to one another inside the container box 1 regardless of the size and shape of the object 3 to be protected. Accordingly, the object 3 inside the container box 1 is packed in a stable and safe manner by the simple packing method of the present invention.

In the present embodiment in the foregoing, the gas is injected inside the packing material 10 after the top cover of the container box 1 is closed. However the gas can also be injected before the top cover of the container box 1 is closed as shown in FIG. 4.

Moreover, the packing material 10 of the present invention can be used by itself. In other words, instead of storing the packing material 10 inside the container box 1, the product to be protected can be packed only by placing it within the space formed by the packing material 10.

### Second Embodiment

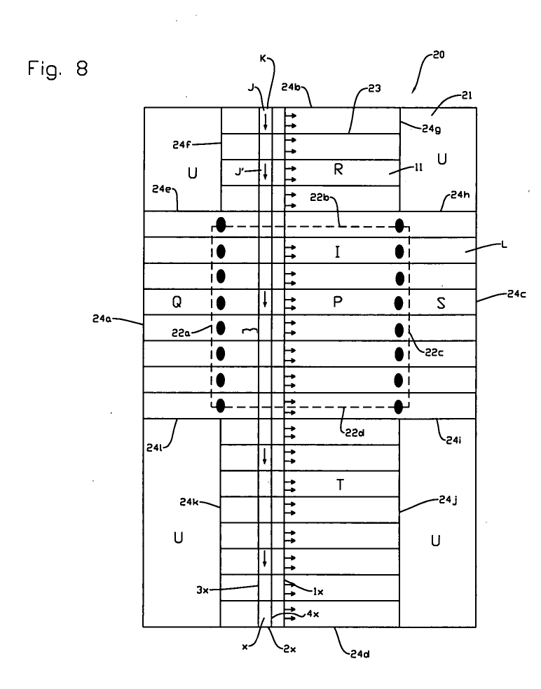

The packing material 10 related to the present invention is not limited to the structure shown in FIG. 1, and can be formed of one rectangular sheet like structure of thermoplastic films as shown in FIG. 8.

FIG. 8 is a plan view showing a base 21 of a packing material 20 used in the second embodiment of the packing method of the present invention.

The packing material 20 of the second embodiment is comprised of two overlapping rectangular thermoplastic films of the same size and shape that are heat-sealed, where a sheet material X which establishes check valves, is held between the two thermoplastic films. A heat-sealing process is applied so that edges 24a-24d, folds 22a-22d, sealing portions 24e-24l, partitions 23, sealing portions 2x-4x, and partially heat-sealed portions 5x, 6x are created where the thermoplastic films are bonded to one another.

In the second embodiment, a slit is formed at each of the sealing portions 24e, 24h, 24i, and 24l on the base 21 where the heat-seal is established as explained above in such a way that the slits work as folding lines so that the entire object 3 can be covered by the packing material 20.

Namely, the side Q is folded up by the slits 24e, 24l and the side S is folded up by the slits 24h, 24i, and the sides U are folded up as well at the sealing portions 24f, 24g, 24k, 24j until the sides U and the side S contact with one another. Consequently, the packing material 20 forms a generally box shape similar to that of the first embodiment.

Since the heat-seal is established on the sealing portions 24e-24l, the sides U are not supplied with the gas, thereby making it possible to easily fold the sides U.

By the simple structure of the packing material 20 noted above where the heat-seal is established to the necessary locations on the rectangular thermoplastic films, the packing material can be obtained by a simple and inexpensive production method.

What is claimed is:

1. A packing material for packing a product to be protected, comprising:
two thermoplastic plastic films overlapped with one another where edges are heat-sealed and gas or liquid is injected therein, and
folds created on the thermoplastic films by heat-sealing the thermoplastic films along predetermined directions to fold the packing material;
wherein the product to be protected is stored in a space created by folding the packing material along the folds.

2. A packing material as defined in claim 1, wherein partitions are formed by heat-sealing the two thermoplastic films to create a plurality of chambers where at least one opening for injecting the gas or liquid is provided thereon.

3. A packing material as defined in claim 2, wherein the opening for injecting the gas or liquid includes a check valve which prevents a reverse flow of the gas or liquid by comprising a labyrinth structure or a narrow pathway in the check valve.

4. A packing material as defined in claim 2, wherein a check valve is provided for preventing a reverse flow of the gas or liquid.

5. A packing material as defined in claim 4, wherein the check valve is provided at the opening for injecting the gas or liquid.

6. A packing material as defined in claim 2, wherein the opening for injecting the gas or liquid is provided through the thermoplastic films.

7. A packing material as defined in claim 2, wherein the opening for injecting the gas or liquid is provided to each chamber established by two adjacent partitions.

8. A packing material as defined in claim 1, wherein the gas or liquid is injected to the packing material after the product to be protected is stored in the space created by fold the packing material.

9. A packing material as defined in claim 1, wherein the packing material having the product therein is placed inside a container box.

10. A packing material as defined in claim 9, wherein the packing material is injected with the gas or liquid after the container box is closed.

11. A packing method for packing a product to be protected therein, comprising the following steps of:
overlapping two thermoplastic plastic films with one another;
applying a heat-seal process to the two thermoplastic plastic film thereby closing edges of the thermoplastic films;
creating folds on the thermoplastic films by heat-sealing the thermoplastic films along predetermined directions;
folding the packing material along the folds so that the product to be protected is stored in a space created by the packing material; and
inflating the packing material by supplying the gas or liquid thereto.

12. A packing method as defined in claim 11, wherein partitions are formed by heat-sealing the two thermoplastic films to create a plurality of chambers where at least one opening for injecting the gas or liquid is provided thereon.

13. A packing method as defined in claim 12, wherein the opening for injecting the gas or liquid includes a check valve which prevents a reverse flow of the gas or liquid by comprising a labyrinth structure or a narrow pathway in the check valve.

14. A packing method as defined in claim 12, wherein a check valve is provided for preventing a reverse flow of the gas or liquid.

15. A packing method as defined in claim 14, wherein the check valve is provided at the opening for injecting the gas or liquid.

16. A packing method as defined in claim 12, wherein the opening for injecting the gas or liquid is provided through the thermoplastic films.

17. A packing method as defined in claim 12, wherein the opening for injecting the gas or liquid is provided to each chamber established by two adjacent partitions.

18. A packing method as defined in claim 11, wherein the gas or liquid is injected to the packing material after the product to be protected is stored in the space created by fold the packing material.

19. A packing method as defined in claim 11, wherein the packing material having the product therein is placed inside a container box.

20. A packing method as defined in claim 19, wherein the packing material is injected with the gas or liquid after the container box is closed.
